(19) United States
(12) Patent Application Publication
(10) Pub. No.: US 2004/0021772 A1
(43) Pub. Date: Feb. 5, 2004

(54) Safety monitoring system

(76) Inventor: Ethel L. Mitchell, Marrero, LA (US)

Correspondence Address: THOMAS S. KEATY, KEATY PROFESSIONAL LAW CORP., 2140 WORLD TRADE CENTER, NO. 2 CANAL STREET, NEW ORLEANS, LA, 70130, US

(21) Appl. No.: 10/208,598

(22) Filed: Jul. 30, 2002

(51) Int. Cl. H04N 7/18

(52) U.S. Cl. 348/148

(57) ABSTRACT

Vehicle safety monitoring utilizes a wireless connection for transmitting signals collected in a controlled site in real time to a display in a control station. The wireless connection operates via an Earth-orbiting satellite and utilizes computers for processing the collected signals and converting them first into a wireless signal and then to an audio/video signal suitable for receiving by a television, video-recording unit or a computer monitor. The controlled vehicle is equipped with a plurality of detecting cameras mounted inside and outside of the vehicle to provide real-time information about activities taking place in and around the vehicle.

### BACKGROUND OF THE INVENTION

The present invention relates to a system for monitoring activity in a controlled location and, more particularly, to a system for collecting audio and video signals at a control location and transmitting the collected data to a control station, such as for instance a monitoring station or a home video display unit.

There are known numerous instances when a crime victim was operating a vehicle or was a passenger in the vehicle and became a victim of abduction, carjacking, and other illegal activity. In some instances, these crimes could be prevented or at least become known to the police or parents of a young victim in real time mode.

Parents of young drivers feel a false sense of security knowing that their child carries a wireless telephone that can be used in case of an emergency. However, in some cases, the cellular telephone can be snatched away from the young victim and destroyed by the attacker before the young victim has a chance to call for help.

Engineers developed various approaches to solving such a problem. For instance, a child may be provided with a bracelet that will send an alarm signal to the transponder unit, which a parent carries. The alert is sounded when the child wanders off outside of the set distance from the transponder. This bracelet can also be taken off the young victim and thrown away by the criminal, thereby rendering the personal locator system useless.

Recent developments allowed small satellite systems orbiting the Earth at low altitudes to provide inexpensive satellite-based telephone monitoring services. Some designs provide for a chip to be implanted under the skin of a person to allow the person's location be detected by search and rescue satellites.

Such systems suffer from a major drawback—they do not provide real time audio and video signals to the persons who are most interested in insuring safety of the child that is the child's parents.

An additional problem that is associated with teenagers or young people driving in a car is that they may consume alcohol while driving, or become passengers in a car driven by a drunk driver. Also, restless young people may create a distractive environment for the driver, thereby endangering the life and safety of all persons present in the car.

If the young driver and the passengers were aware that a camera placed in the car and outside the car sends real-time signals to the parent's computer or television set, this may serve as a deterrent to the careless behavior of young people.

The present invention contemplates provision of a safety monitoring system that collects, processes and sends real time audio and video signals using a conventional wireless phone link with a satellite for transmission to a control station, be it a safety monitoring station, parent's television, home computer, etc.

### SUMMARY OF THE INVENTION

It is, therefore, an object of the present invention to provide a safety monitoring system that operates via wireless telephone connection with a remote control video display.

It is another object of the present invention to provide a safety monitoring system that provides real time audio and video connection between a controlled object and a remote audio/video monitor.

It is a further object of the present invention to provide a safety monitoring system that can be used for positioning in a vehicle for transmitting signals indicative of the activity in and around the vehicle in real time.

These and other objects of the present invention are achieved through a provision of a system and method for monitoring activity in and around a controlled vehicle. The vehicle may be a land-based, aircraft or watercraft vehicle. The system uses wireless telephone connection that transmits signals collected inside and outside of a vehicle to a control station via an Earth-orbiting satellite.

A plurality of small cameras are secured on the inside and outside of a vehicle to collect audio and video signals. The signals are then converted into wireless signals by a computer mounted in the vehicle and powered by the vehicle battery. The signals are then sent to a conventional transmitting tower and to the satellite, from where the signals are picked up by the receiving tower and sent to a control computer.

The wireless signals are processed to generate real-time audio/video signals, which are then sent to a control display, such as TV, computer monitor, or recorded by a VCR in the remote control location.

### BRIEF DESCRIPTION OF THE DRAWINGS

Reference will now be made to the drawings wherein like parts are designated by like numerals, and wherein FIG. 1 is a block diagram of the safety monitoring system of the present invention.

FIG. 2 is a schematic view of a vehicle equipped with the audio/video detecting units for collecting data on the activity in and around the vehicle.

### DETAILED DESCRIPTION OF THE PREFERRED EMBODIMENT

Turning now to the drawings in more detail, the safety monitoring system of the present invention is designated by numeral 10 in FIG. 1. The system 10 utilizes a wireless telephone connection operating in conjunction with a low Earth-orbiting satellite to transmit signals from a controlled location to a video/audio display of a control station.

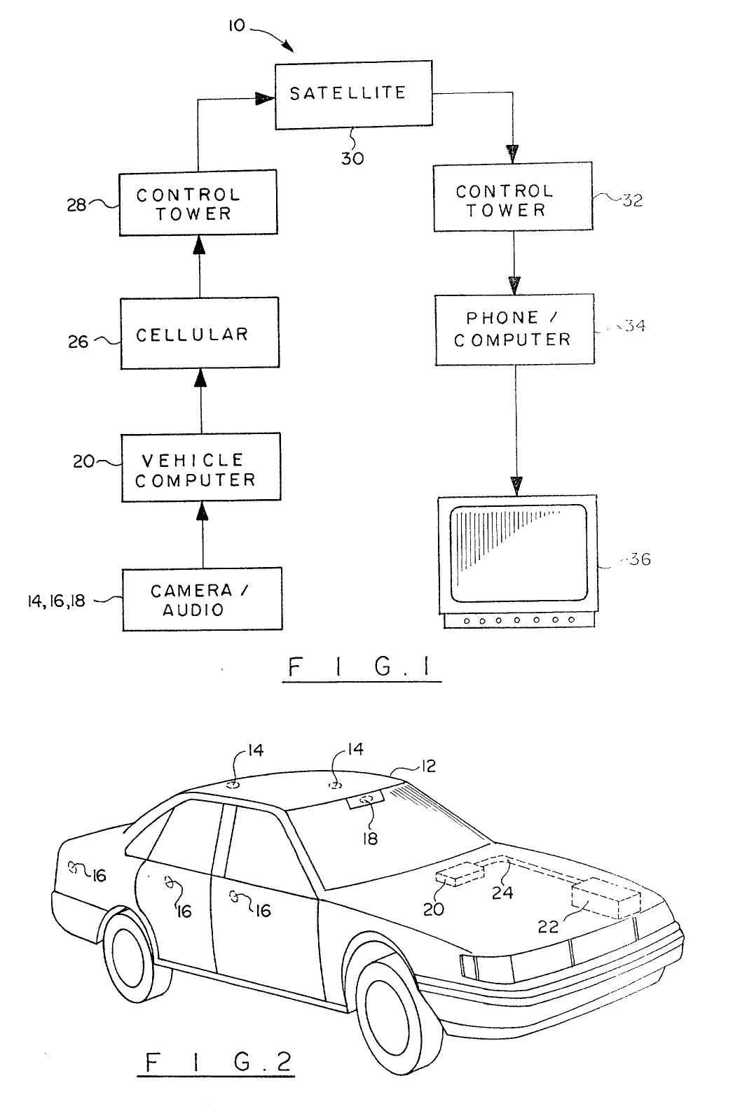

To make use of the safety monitoring system of the present invention, a plurality of detecting means, such as audio/video receivers are mounted on the inside and outside of a vehicle. A schematic view of FIG. 2 illustrates a car 12 having one or more sensors 14 mounted on the roof of the car, one or more sensors 16 mounted on the side of the car, and one or more sensors 18 mounted inside the car, for instance on a rear view mirror.

The sensors 14, 16 and 18 are audio and video receivers, such as small cameras, which are interconnected through the electrical system of the vehicle to a computer/phone unit 20 mounted inside the vehicle. The computer/phone unit 20 is powered by a vehicle battery 22, to which it is connected by suitable cables 24. A signal detected by the cameras 14, 16, and 18 is dent to the car computer 20, which in turn communicates through a wireless telephone line, such as for instance cellular telephone 26, with a control tower 28.

The system of the present invention utilizes wireless telephone technology and existing control tower positions which are equipped and capable of receiving signals from the cellular telephone unit 26 and transmitting them to a communication satellite 30. The communication satellite 30 communicates with a second control tower 32 in sending the signal collected by the cameras 14, 16, and 18 to a processing unit, such as computer 34 equipped with conventional telephone lines or capable of receiving wireless telephone signals. The unit 34 processes the telephone signals and converts them to audio/video signals suitable for display on a video display.

The processed signal is transmitted to a video/audio monitor 36, which is positioned in a controlled location, such as for instance a monitoring station or a home. The display unit 36 can be a computer monitor, a television screen, or a recording device, for instance a VCR. The computer 34 and the car computer 20 can be a one-way or two-way messaging units, allowing the monitoring station to communicate with the car passengers or driver via satellite and wireless telephone connections.

If desired, the vehicle computer 20 can be programmed to prevent disengagement of the cameras 14, 16 and 18 and disabling of the monitoring process. The vehicle computer 20 can be programmed to start operation of the cameras 14, 16, and 18 as soon as the battery 22 is engaged.

This function may be particularly important for security vehicles, such as bank security vehicles designed to transport currency and precious metals from one location to another. By equipping such a vehicle with cameras inside and outside the vehicle, the controlling station can monitor activity in and around the vehicle, sending real time direct signals from the controlled location to the monitoring station. Any unusual activity in and around the vehicle can be immediately detected by the personnel of the control station, and police can be alerted as to the unusual activity. If the computer 34 is programmed to execute simultaneous connection to a video recording unit, information on criminals is recorded and can be successfully used in apprehending the criminals.

In situations when the car 12 is equipped with a system of the present invention, the information on the activity in and around the car can be transmitted directly to a monitoring station or to the home of the car owner. There, the parent may see in real time the actions of the driver and the passengers and communicate with the car via a satellite/cellular link. It is envisioned that the presence of the safety monitoring system of the present invention in a car used by young people may serve as a strong deterrent against careless behavior during driving.

Similarly, the controlling/monitoring station can see an attempted carjacking while the crime is in progress. Real time signals collected by the cameras 14, 16, and 18 and transmitted via satellite connection 30 to the monitoring station 36 can be used to immediately dispatch a police unit to the location where the carjacking is taking place. The direct video connection may also assist in apprehending the criminals and the extent of the criminal activity in and around the vehicle.

The safety monitoring system of the present invention can be also positioned in airplanes while the control tower can see real time activities inside the plane. The control station will be able to see and detect any unusual activity in the cockpit of in the airplane or in the main cabin of the plane. Since cameras 14, 16, and 18 are equipped with audio/video receivers, the conversation around the vehicles and inside the vehicles can be transmitted via satellite unit 30 to the control station to allow the monitoring persons to evaluate whether the situation is dangerous and requires intervention.

It is envisioned that the camera 18 may be a video camera equipped with a small screen on which the image of the controller can be displayed to be seen by the occupants of the vehicle to facilitate communication between the occupants of the vehicle and the control station.

It is also envisioned that the rear of the vehicle can be provided with additional audio/video receivers, such that a combined signal surrounding the vehicle 360 degrees can be developed for processing by the computer unit 20 and transmission to the receiving computer unit 34.

The system of the present invention may be used for monitoring activities around banks security vehicles, construction equipment, and other similar vehicles.

Of course, each of the elements described above, or two or more together may also be useful in other types of methods different from the type described above. Many other changes and modifications can be made in the system of the present invention without departing from the spirit thereof. I therefore pray that my rights to the present invention be limited only by the scope of the appended claims.

I claim:

1. A monitoring system for vehicles, comprising:
a plurality of detecting means mounted on a body of a vehicle for collecting real-time data on activity in and around a vehicle;
a means for converting signals detected by said detecting means to a wireless signal and forwarding said signal to an Earth-orbiting satellite;
a means for receiving the wireless signal and converting the wireless signals to audio/video signals; and
a means for displaying the audio/video signals on a display unit in a remote control location.

2. The system of claim 1, wherein said detecting means are cameras mounted inside and outside of the vehicle.

3. The system of claim 1, wherein said means for converting the signals to a wireless signal comprise a computer mounted in the vehicle and operationally connected to the vehicle power source.

4. The system of claim 1, wherein said means for converting the wireless signal is a computer unit positioned in a control location, said computer unit being capable of receiving the wireless signal.

5. The system of claim 1, wherein said display means is a television unit positioned in the control location.

6. The system of claim 1, wherein said display means is a computer monitor positioned in the control location.

7. The system of claim 1, wherein said system further comprises a recording device positioned in the control location for recording the audio/video signals processed by said means for processing the wireless signal.

8. The system of claim 1, wherein said means for converting said signals into a wireless signal comprise a cellular telephone connection line.

9. The system of claim 1, wherein said vehicle is a land-based, aircraft or a watercraft vehicle.

10. A method of monitoring activity in and around a vehicle, comprising the steps of:
providing a plurality of detecting means for detecting activity in and around the vehicle;
converting signals detected by said detecting means to a wireless signal and transmitting said wireless signal, via an Earth-orbiting satellite, to a processing means;
processing said wireless signal and converting said wireless signal to audio/video signals; and
displaying said audio/video signals in real time in a display means positioned in a remote control station.

11. The method of claim 10, wherein said step of converting the signals comprises providing a cellular telephone line connection.

12. The method of claim 10, wherein said step of converting the signal comprises providing a computer unit positioned in said vehicle.

13. The method of claim 12, wherein said computer unit is powered by a battery operating said vehicle.

14. The method of claim 10, wherein said step of processing the wireless signal comprises a step of providing a computer and positioning said computer in the remote control location.

15. The method of claim 10, wherein said step of displaying said audio/video signals comprises a step of providing a recording means for recording said audio/video signals in the remote control location.
